(19) United States
(12) Patent Application Publication
(10) Pub. No.: US 2019/0236593 A1
(43) Pub. Date: Aug. 1, 2019

(54) CRYPTOCURRENCY CONVERSION

(71) Applicant: MIXED IN KEY LLC, Miami, FL (US)

(72) Inventors: Yakov VOROBYEV, Miami, FL (US); Betsy MAGDE, Miami, FL (US)

(73) Assignee: MIXED IN KEY LLC, Miami, FL (US)

(21) Appl. No.: 16/230,664

(22) Filed: Dec. 21, 2018

Related U.S. Application Data
(60) Provisional application No. 62/622,651, filed on Jan. 26, 2018.

(51) Int. Cl. G06Q 20/36; G06Q 20/40; G06Q 40/04

(52) U.S. Cl. CPC G06Q 20/3678; G06Q 2220/00; G06Q 40/04; G06Q 20/401

(57) ABSTRACT

To purchase goods or services using an arbitrary cryptocurrency, an amount of the cryptocurrency can be transferred to a decentralized electronic ledger and an amount of another cryptocurrency can be transferred to another decentralized electronic ledger using cryptographic keys. A sequence of exchange operations is selected by which the cryptocurrency is exchanged for fiat currency, which include an entry into the decentralized electronic ledger requiring a cryptographic signature using the cryptographic keys and another entry into the other decentralized electronic ledger requiring another cryptographic signature using other cryptographic keys. A temporal window is determined defining a time in which the sequence of exchange operations is to be completed based on an estimated time for completion of the entry into the decentralized electronic ledger and an estimated time for completion of the other entry into the other decentralized electronic ledger. The sequence of exchange operations is executed in response to initiation thereof through the user interface within the temporal window.

### RELATED APPLICATION DATA

This application claims benefit of priority under 35 U.S.C. § 119(e) from U.S. Provisional Patent Application No. 62/622,651 entitled “SYSTEM AND METHOD FOR BLOCKCHAIN CONVERSION AND MERCHANT PAYMENT ACCEPTANCE OF ALL CRYPTOCURRENCIES,” filed Jan. 26, 2018, the entire disclosure of which is incorporated herein by reference

### BACKGROUND

A cryptocurrency is a digital asset that is designed as a medium of exchange and that uses cryptography to secure financial transactions, control the creation of additional units and verify the transfer of assets. There are currently over a thousand different cryptocurrencies, each having its own ledger and transaction protocol, and the introduction of new cryptocurrencies is ongoing.

Widespread adoption of cryptocurrency as payment for goods and/or services is hampered by several limitations. First, merchants require a separate cryptocurrency wallet for each cryptocurrency in which payment for goods and services will be accepted. With over a thousand cryptocurrencies, the overhead of maintaining a separate cryptocurrency wallet for each cryptocurrency may be prohibitive to some merchants. Another limitation is that cryptocurrency can be stolen by hackers and merchants may be averse to the risk of having too many financial resources tied up in cryptocurrency. Additionally, certain cryptocurrencies blockchains charge high transaction fees, which translates into higher prices for consumers.

### SUMMARY

Cryptographic keys are stored in a memory with which an amount of cryptocurrency can be transferred to a memory location in a decentralized electronic ledger. In another memory, other cryptographic keys are stored with which an amount of another cryptocurrency can be transferred to a memory location in another decentralized electronic ledger. A user interface is generated on a display device that includes a control by which units of the cryptocurrency are selected. A sequence of exchange operations is selected by which the cryptocurrency is exchanged for fiat currency. The sequence of exchange operations include an entry into the decentralized electronic ledger requiring a cryptographic signature using the cryptographic keys and another entry into the other decentralized electronic ledger requiring another cryptographic signature using the other cryptographic keys. A temporal window is determined defining a time in which the sequence of exchange operations is to be completed based on an estimated time interval for completion of the entry into the decentralized electronic ledger and an estimated time interval for completion of the other entry into the other decentralized electronic ledger. The sequence of exchange operations is executed in response to initiation thereof through the user interface within the temporal window.

### BRIEF DESCRIPTION OF THE DRAWINGS

FIG. 1 is a schematic block diagram of an example system configuration in which the present inventive concept can be embodied.

FIG. 2 is a flow diagram of an example transaction process by which the present inventive concept can be embodied.

FIG. 3 is a sequence diagram of an example transaction through an embodiment of the present inventive concept.

FIG. 4 is a diagram of an example user interface of an embodiment of the present inventive concept.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

The present invention, which is practiced in the realm of cryptocurrency, is necessarily rooted in computer technology in order to overcome a problem specifically arising in the realm of computer networks, i.e., paying for goods and services using an arbitrary cryptocurrency.

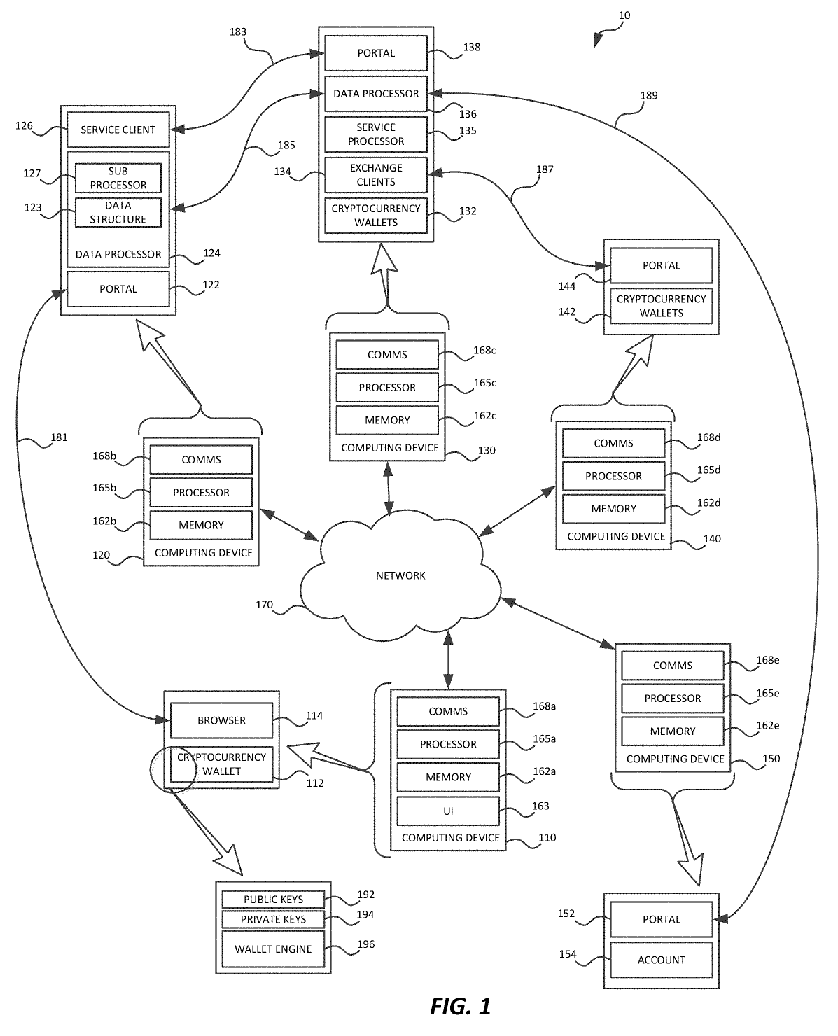

FIG. 1 is a schematic block diagram of an example system 10 by which the present invention can be embodied. By way of system 10 and the techniques described herein, a merchant's customer may pay for goods and/or services, alternatively referred to herein as deliverables, in an arbitrary cryptocurrency. In brief, a consumer may place an order at a merchant's web site and may specify an arbitrary cryptocurrency with which to make payment. System 10, as described in detail below, provides a purchase price in the arbitrary cryptocurrency for the items specified in the order (e.g., the items in an e-commerce shopping cart). If the customer agrees to the purchase price and submits to such (e.g., by activating a payment submit control or otherwise initiating the transaction), the merchant is paid in fiat currency and the order for the goods and/or services is placed. The merchant can then complete the transaction (e.g., delivering digital goods, shipping physical goods or performing services) in its normal course of business.

Computing device 110, referred to herein as customer device 110 may be utilized by a consumer to interact with system 10, i.e., to purchase goods and/or services from a merchant operating computing device 120, referred to herein as merchant device 120. To that end, customer device 110 may implement a user interface, such as a browser 114, through which a customer can communicate with merchant device 120 to shop for items, place orders for items, pay for the items in the order, and other e-commerce activities known to skilled artisans.

In certain embodiments, functionality of customer device 110 may be implemented by a point-of-sale (POS) or kiosk device. As is known in the art, similar mechanisms that would be provided by a browser on a user's computer device (e.g., computer, mobile device, etc.) may be employed on a computer device configured as a POS device. As will be apparent to skilled artisans upon review of this disclosure, the present invention may be embodied in a wide variety of computer devices without departing from the spirit and intended scope thereof.

Merchant device 120 may be operated by a merchant to conduct e-commerce over network 170. Accordingly, merchant device 120 may implement a portal 122, referred to herein as consumer portal 122, with which to communicate with customer device 110, a data processor 124, referred to herein as an e-commerce processor 124, to accept orders (items stored in data structure 123, referred to herein as a shopping cart data structure 123) and to initiate payment for such orders through a sub processor 127, referred to herein as a payment processor 127. Merchant device 110 may also include a service client 126 with which to communicate with computing device 130, referred to herein as service device 130.

Server device 130 may be operated by a service provider to process and track payments in a cryptocurrency that has been selected by the customer for payment. Accordingly, server device 130 may include one or more exchange clients 134 that communicate with respective cryptocurrency and currency exchanges, a service processor 135 that implements certain service functionality, e.g., tracking market and exchange statistics, imposing a transaction window (as described below), determining best transaction rates and fees, etc., a data processor 136, referred to herein as a transaction processor 136, by which transactions in both cryptocurrency and fiat currency are conducted and portal 138, referred to herein as a merchant portal 138, with which to communicate with merchants via service client 126.

Computing device 140, referred to herein as a exchange device 140, may be operated by a cryptocurrency exchange at which cryptocurrencies are traded for other cryptocurrencies as well as fiat currencies. In certain embodiments, more than one exchange is used—one for trading a cryptocurrency that is not directly convertible into a fiat currency for one that is and a second exchange for trading the latter cryptocurrency for fiat currency. Each of the exchange devices 140 may be associated with separate exchanges and may comprise a portal 144, referred to herein as a trading portal 144, with which to communicate with server device 130.

Computing device 150, referred to banking device 150, may be operated by a financial institution to accept funds in fiat currency for purchased items on behalf of the merchant. To that end, banking device may realize a portal 154, referred to herein as a banking portal 154, with which to communicate with server device 130 and provide access to an account 154, referred to herein as a merchant account 154.

Customer device 110, server device 130 and exchange device 140 may implement one or more cryptocurrency wallets 112, 132 and 142, respectively. As is known to those skilled in cryptocurrency, a cryptocurrency wallet is a combination of storage hardware and credentials encoded or otherwise stored on that storage hardware; the cryptocurrency itself is not stored in the cryptocurrency wallet. The cryptocurrency itself exists as entries of a distributed digital ledger, such as a blockchain. The cryptocurrency wallet maintains the credentials (e.g., public keys 194 and private keys 192) that allow access to that ledger. In certain implementations, the cryptocurrency wallet is equipped with hardware and/or software mechanisms, e.g., wallet engine 196, by which transactions are cryptographically signed using the private key of the cryptocurrency wallet. Additionally, wallet engine 196 may broadcast transactions over a network 170 using corresponding cryptocurrency network mechanisms and protocols known in the art. Upon review of this disclosure, those having skill in the art will recognize different techniques by which the functionality of a cryptocurrency wallet are fulfilled to embody the present invention. In FIG. 1, wallet engine 196 represents an implementation of such functionality.

System 10 may be understood by skilled artisans as comprising a plurality of processing nodes, i.e., customer device 110, merchant device 120, server device 130, exchange device 140 and banking device 150, communicatively coupled one to another through network 170. The underlying telecommunication infrastructure of system 10 may be achieved using standard telecommunication techniques, protocols and signaling interfaces. Skilled artisans will recognize the underlying techniques and mechanisms required to carry out general interoperability of network components without implementation details being explicitly set forth herein. Disclosure of such techniques will be omitted for purposes of conciseness.

As illustrated in FIG. 1, the processing nodes may comprise respective memories 162a-162e, representatively referred to herein as memory (memories) 162, processors 165a-165e, representatively referred to herein as processor(s) 165 and communication circuits 168a-168e, representatively referred to herein as communication circuit(s) 168. Customer device 110 may also include user interface circuitry 163 through which a customer interacts with system 10. The computing nodes, i.e., customer device 110, merchant device 120, server device 130, exchange device 140 and banking device 150, define distributed computational resources that interoperate through various communication channels formed in network 170 and realize thereby the functionality described herein.

Customer device 110 may interoperate with merchant device 120 through an interface 181. Interface 181 may be realized through a web client, e.g., browser 114, and consumer portal 122, which may implement a web server. Through interface 181, a consumer may place an order for goods and/or services using an arbitrary cryptocurrency using suitable controls rendered in a web page. The customer may collect a number of items into an order, which may be stored together in a suitable data structure, such as shopping cart data structure 123.

Merchant device 120 may interoperate with server device 130 through an interface 183 and an interface 185. Interface 183 may implement features of an application programming interface (API) between a service client 126 and a merchant portal 138. Such features may include establishing and maintaining merchant accounts and profile information, communicating transaction related messages, etc.

Interface 185 may implement features of an API that is used for transaction processing between payment processor 127 and transaction processor 136. Such transaction processing may include receiving an indication of the cryptocurrency in which payment is to be made and acting as an automated agent of the merchant in conducting the various operations required by the transaction, as will be described in more detail below.

Interface 189 may implement features of an API between a client, i.e., transaction processor 136, and a server, i.e., banking portal 152. Through interface 189, access to the merchants account, albeit limited, is granted for purposes of accepting payment on behalf of the merchant for goods and/or services provided.

Server device 130 may interoperate with one or more exchange device(s) 140 through an interface 187. Interface 187 may implement features of an API between an exchange client 134 and a trading portal 144 for each exchange device 140 included in system 10. Server device 130 may realize several exchange clients 134, one for each exchange included in system 10.

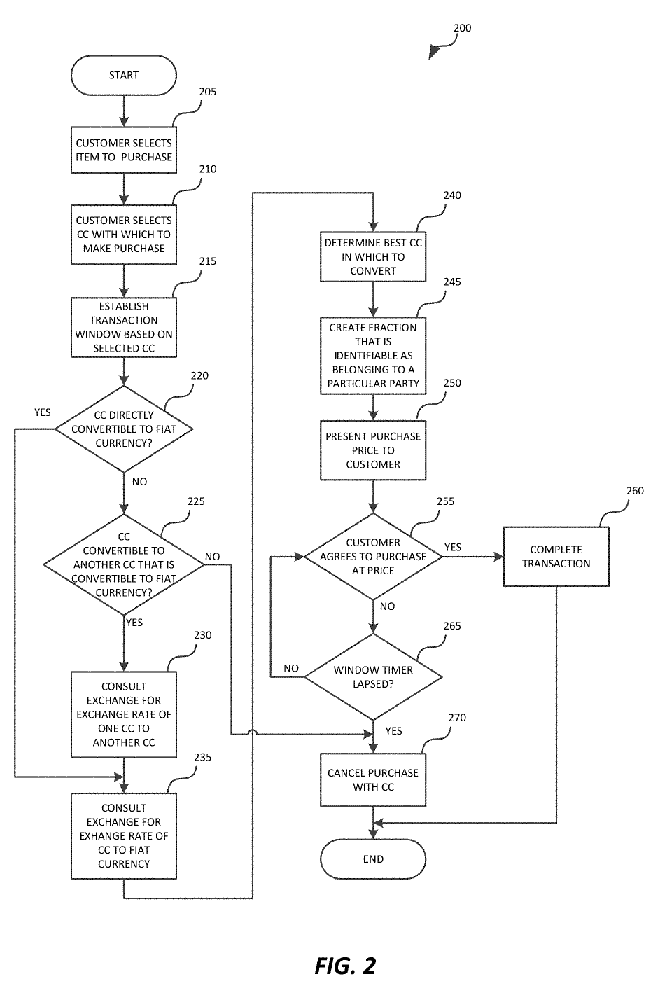

FIG. 2 is a flow diagram of an example transaction process 200 by which the present invention may be embodied. In this example, a customer uses a client device 110 configured as illustrated in FIG. 1 to select an item for purchase at a merchant's e-commerce web site. This may be achieved in a conventional manner by utilizing browser 114 to interact with consumer portal 122. The customer may place items for purchase in shopping cart 123 of e-commerce processor 124. As used herein, a shopping cart is a data structure containing objects that represent items for purchase. Control over what is contained in the shopping cart data structure, and thus what is in a single order, is achieved by various controls rendered in a web page or POS interface so as to operate like a traditional shopping cart. Objects may be added and removed from the shopping cart data structure through suitable add (continue shopping) and remove controls rendered in a web page.

Payment processor 127 may have a control rendered in a web page by which the customer can select the cryptocurrency with which to make the purchase. Such a control may include a drop-down selection control through which the customer selects or otherwise inputs the desired cryptocurrency (units of cryptocurrency, e.g., Bitcoin, Etherium, Litecoin, Dogecoin, various altcoins, etc.) he/she will use to pay for the goods and/or services represented in shopping cart 123. Other types of controls may be used for this purpose as well. Such a web page may also include a display control that displays a price for shopping cart items in the selected cryptocurrency as well as a payment submit control by which a customer can digitally agree to the transaction and initiate payment for the shopping cart items in the selected cryptocurrency. Those having skill in web design or point-of-sale system design will recognize numerous controls other than those described herein that can be used to embody the transaction control features of the present invention without departing from the spirit and intended scope thereof.

In operation 205, the customer selects an item for purchase, such as by placing the items in a shopping cart. In operation 210, the customer may select units of a cryptocurrency (CC) in which to pay for the order. Such may be achieved by rendering the drop-down control described above in the shopping cart web page.

In operation 215, a transaction window is established, the length (in time) of which depends on the selected cryptocurrency. As used herein, a “transaction window” is a time period in which all cryptocurrency transactions must be completed in paying for an order for goods and/or services from a merchant. The length of the transaction window may be based on different factors including information (e.g., market volatility/price stability of the cryptocurrencies involved) derived from various market statistics (e.g., historical buy/sell data, market capitalization, etc.), processing time (which includes block times of the cryptocurrencies involved), the time required to withdraw fiat currency from a particular exchange, etc. In certain embodiments, service processor 135 constantly monitors such information, market statistics, processing times, etc., as a background process and predicts window lengths for different cryptocurrencies in an ongoing manner. In certain embodiments, a first exchange from one cryptocurrency into another, referred to herein as a cryptocurrency trading pair, is conducted and then a second exchange from the other cryptocurrency into fiat currency, referred to herein as a crypto-fiat trading pair, must be completed within the transaction window. The transaction window may be enforced through a suitable timer that generates a signal upon its expiry.

In certain embodiments, the stability of a cryptocurrency's price is a key factor in not only determining the length of a transaction window, but in determining whether the transaction should proceed at all. The price stability establishes whether the merchant will receive very close to the original sale price by the time the transaction is fully cleared. Thus, embodiments of the present invention ensure that a) there's at least one exchange that can accept the cryptocurrency that the customer has selected, and b) that the selected cryptocurrency can indeed be converted to another cryptocurrency, (e.g., a type of mainstream cryptocurrency such as Bitcoin or Ethereum) that can be easily sold for US dollars or another fiat currency. If there are some problems in the sequence of exchange operations, server device 130 may reject the transaction. For example, at certain times, a transaction may take hours to get incorporated into a very busy blockchain, so accepting payments during that time incurs a risk that a later exchange operation may no longer occur as originally planned (a price change, for example). If transactions are being recorded in the blockchain smoothly and transactions are being confirmed quickly, then a 5-10 minute window may be sufficient.

In operation 220, it is determined whether the cryptocurrency is directly convertible into a fiat currency. If not, process 200 transitions to operation 225, by which it is determined whether the cryptocurrency can be converted into another cryptocurrency that can itself be converted into fiat currency. If such is not the case, process 200 may transition to operation 270, whereby the purchase is canceled. If it is the case that the cryptocurrency can be converted into another cryptocurrency that can itself be converted into fiat currency, process 200 transitions to operation 230, by which first exchanges are consulted as to current exchange rates (buy/sell data) of the customer's selected cryptocurrency into another cryptocurrency that can be exchanged for fiat currency. In operation 235, second exchanges, which in some cases may be the same exchange as the first exchange, may be consulted as to current exchange rates of the other cryptocurrencies into fiat currency. Note that operation 235 is also performed upon a determination in operation 200 that the selected cryptocurrency is directly convertible to fiat currency.

In operation 240, it is determined which cryptocurrency trading pair and which crypto-fiat trading pair results are “best” in terms of various considerations, where selection criteria that establishes what is “best” may include the highest overall rate of exchange of the customer's selected cryptocurrency into fiat currency that can be used to purchase the goods and/or services from the merchant, the lowest transaction fees charged by the cryptocurrency networks, the length of transaction window of the cryptocurrencies involved, the time required for fiat currency to be withdrawn, etc. Other parameters may be used as well.

In operation 245, which is an optional operation, the amount determined in operation 240 is modified by a fractional amount so that the transaction is identifiable from the sequence of numbers forming the purchase price. Transactions of many cryptocurrencies are anonymous and it is thus difficult to match a customer with payment for an individual order, particularly when there is only a single cryptocurrency wallet for each cryptocurrency used in system 10. In certain embodiments, tracking customer payments may be achieved by modifying the purchase price to contain a specific sequence of digits in its fractional part and associating the specific sequence of digits to the order, such as via a lookup table or other database hosted by the merchant of the payment processor. For example, one embodiment may indicate a price of 0.1234500006789 coins, where 0.12345 coins is the price of the order including fees and 0.00006789 may be a tracking number established in the price. Such a tracking number may an order number, invoice number or the like converted into a decimal fraction and added to the price of the order. Payments received having that same sequence of digits can be used as an index into the lookup table or other database to determine which order is being paid for by that payment. The sequence of digits may be generated by suitable number generation techniques. Certain precautions can be taken so that the same sequence of digits is not used twice in predetermined amount of time.

As explained, optional operation 245 allows embodiments of the invention to track orders in an anonymous cryptocurrency protocol. However, other techniques may be used for such tracking purposes. For example, some cryptocurrency protocols allow a memo to be attached to the transaction data structure that could indicate an invoice or order number. The present invention is intended to embrace such alternative tracking mechanisms.

In operation 250, the modified purchase price is presented to the customer, such as on browser 114. In one embodiment, shopping cart controls display the price for each object in the shopping cart data structure as well as a total price in the selected cryptocurrency that includes various fees (including blockchain transaction fees, service fees, etc.). In operation 255, it is determined whether the customer agrees to the purchase price for the order and, if so, process 200 may transition to operation 260, whereby the transaction is completed. Exemplary operations for completing a transaction in one embodiment of the invention are described in more detail below. If it is determined in operation 255 that the customer has not agreed to the purchase price, process 200 may transition to operation 265, whereby it is determined whether the transaction window timer has lapsed. If so, process 200 transitions to operation 270 at which point the process terminates the transaction without completion.

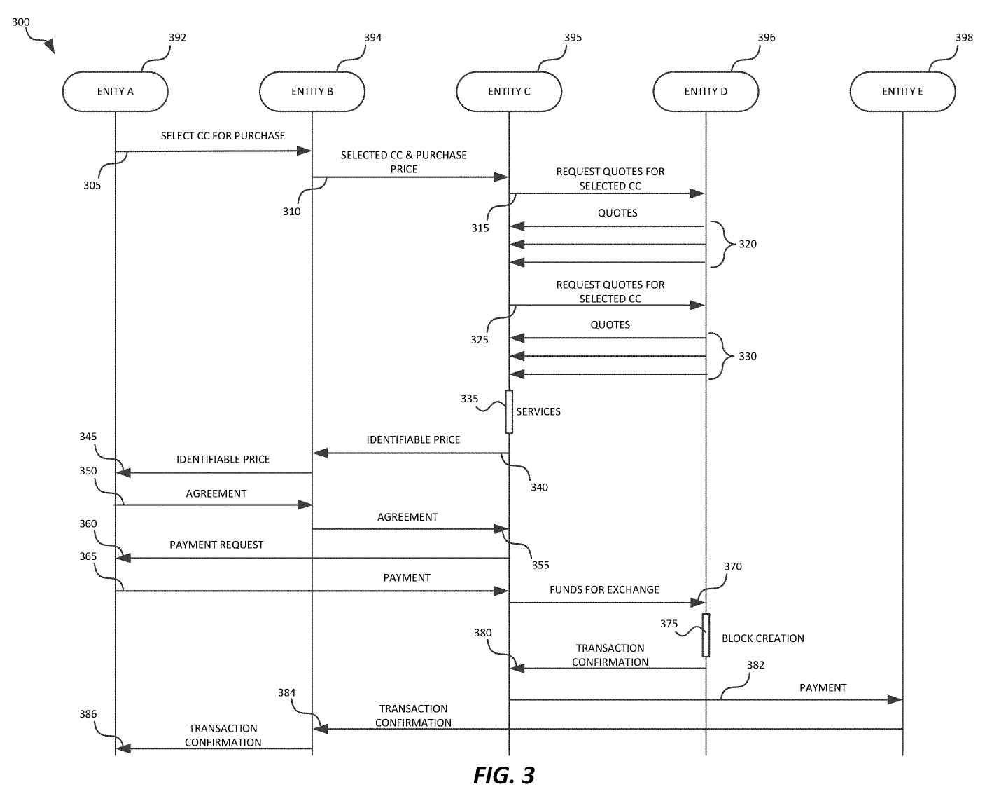

FIG. 3 is a sequence diagram of an example transaction 300 performed by an embodiment of the present invention. Embodiments of the present invention may realize a sequence of exchange operations in which a selected cryptocurrency is exchanged for a cryptocurrency that itself can be exchanged for fiat currency, and then exchanging the latter cryptocurrency for the fiat currency to use for payment for deliverables.

As illustrated in FIG. 3, the transaction involves an entity A 392, referred to herein as a customer 392, operating a customer device 110, an entity B 394, referred to herein as a merchant 394, operating a merchant device 120, an entity C 395, referred to herein as a service provider 395, operating a server device 130, one or more entities D 396, referred to herein as one or more exchanges 396, operating respective exchange devices 140 and an entity E 398, referred to herein as a bank 398, operating a bank device 150. Customer 392 begins by selecting a cryptocurrency to use for purchasing goods and/or services, as illustrated at operation 305. Merchant 394 receives the cryptocurrency selection and, in operation 310 forwards the selected cryptocurrency along with the purchase price to service provider 395. Service provider 395 may format a suitable request for quotes (current exchange rate) from various exchanges 396 and forward the request(s) to the various exchanges in operation 315. In addition to quotes, service provider 395 may receive other information, such as market statistics, as described above. In operation 320, the exchanges 396 return respective quotes (and other information) to service provider 395; several different cryptocurrencies into which the selected cryptocurrency can be exchanged can be sought from exchanges 396. Service provider 395 may prepare another request for quotes from exchanges 396, this time for exchange rates of the different cryptocurrencies into fiat currency, and may forward the request to exchanges 396 in operation 325. In operation 330, the exchanges return respective quotes (and other information) to service provider 395.

At this point in transaction 300, service provider 395 has sufficient information to determine the cryptocurrency trading pair and crypto-fiat trading pair that offers the best exchange rate in terms of fiat currency for the customer's selected cryptocurrency, where “best” can favor the customer, the merchant or the exchange. Such a determination may be made during services period 335, which may also include time for determining the temporal transaction window, determining a price in the customer's selected cryptocurrency and for modifying the price into the identifiable price described above. In operation 340, service provider 395 may forward the identifiable price to merchant 394, which in turn forwards the identifiable price to the customer 392 in operation 345, such as by displaying the price in the selected currency on browser 114. In operation 350, an indication that the customer agrees with the purchase price is sent to merchant 394, such as initiating the transaction by sending the agreed upon amount to the service provider's wallet address, which in turn forwards the indication to service provider 395 in operation 355.

In operation 360, service provider 395 may request payment of the agreed upon purchase price in the customer's selected cryptocurrency from customer 392. This may be achieved by providing to customer 392 the address of the cryptocurrency wallet 132 corresponding to the customer's selected cryptocurrency. The customer may use its cryptocurrency wallet 112 to provide payment in operation 365, which, as known in the art, includes cryptographically signing the transaction with private key 192 maintained by cryptocurrency wallet 112. In operation 370, cryptocurrency funds for exchange are indicated to the exchanges 396 using the exchanges with the best rate for the cryptocurrency trading pair and the crypto-fiat trading pair, at which time the funds are exchanged. The exchange from cryptocurrency to fiat currency may include another cryptographic signature using a private key in cryptocurrency wallet 142. Indeed, each time an amount of cryptocurrency is transferred from one entity to another, the transaction may require such a cryptographic signature.

After block creation times indicated at 375, the pertinent exchanges 396 may provide service provider 395 with an indication that the transaction has been completed in operation 380. In operation 382, service provider 395 may deposit payment in fiat currency into merchant's bank 398, which may then indicate a transaction confirmation to merchant 394. Merchant 394 may forward a transaction confirmation to customer 392 in operation 386.

In certain embodiments, the service provider allows the merchant's account to be accessed through the service provider API discussed above (e.g., interface 189). The service provider API may connect may connect to different exchanges using the merchant's credentials to automate the behavior of buying/selling/trading cryptocurrency on those exchanges. Thus, the fiat currency may be transferred from an exchange to the merchant by a) from a service provider account to the merchants fiat account or by b) from a merchant's account on an exchange to the merchant's fiat account, which may be at a separate financial institution.

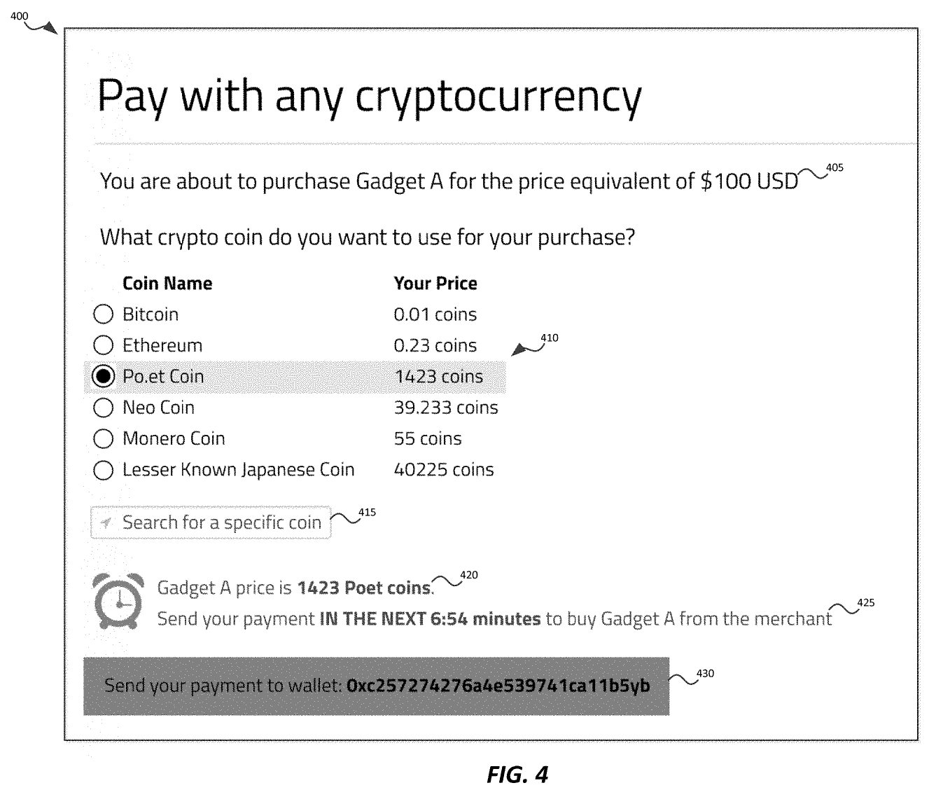

FIG. 4 is a diagram of an example user interface component 400 that can be used in embodiments of the present invention. User interface component 400 may be constructed or otherwise configured to be rendered in a web browser, such as browser 144 in FIG. 1, and may be outfitted with various controls through which information is relayed to a user and through which the user can interact with system 10. In certain embodiments, user interface component 400 is incorporated into an e-commerce shopping cart mechanism. Those having skill in user interface technology will recognize numerous interface configurations that may be used in conjunction with the present invention to realize the user interface functionality described herein without departing from the spirit and intended scope of the present invention.

User interface component 400 may include an interface control 405 by which information regarding the transaction at hand is displayed to the user. For example, interface control 405 may convey what items are in the order and the total purchase price of the order as specified by the merchant.

User interface component 400 may include interface controls by which a cryptocurrency to use for the purchase can be selected by a user. For example, a list of popular cryptocurrencies 410 may be displayed along with a selection control 412 by which one of the cryptocurrencies is selected. Alternatively, or additionally, user interface component 400 may include a search control 415 by which the user can search for a particular cryptocurrency in which to conduct the transaction. If the sought after cryptocurrency is found, it can be displayed on user interface component 400, such as in the list 410. The user can then make the selection of the cryptocurrency in which to transact.

User interface component 400 may further include an interface control 420 by which a price for the order in the selected cryptocurrency is provided to the user. In addition to the actual price of the order, the displayed price may include service fees, transaction fees and an optional fractional amount used to identify a transaction, as described above. In certain embodiments, a detailed breakdown of the items included in the displayed price may be displayed to the user on user interface component 400.

User interface component 400 may further include an interface control 425 by which remaining time in the transaction window is displayed. As explained above, the user must initiate the purchase of the order within the transaction window in order for the purchase to proceed. Otherwise, a new price and a new transaction window may have to be determined.

User interface component 400 may include an interface control 430 that indicates to the user a target address to which to send the price amount of the selected cryptocurrency. Such action, i.e., the user sending the price amount of the selected cryptocurrency to the indicated address, initiates the transaction and thus must be performed prior to expiry of the transaction window. Such sending of the selected cryptocurrency may be performed using the customer's cryptocurrency wallet, such as cryptocurrency wallet 112 in FIG. 1.

System 10 may be implemented in a client-server system, database system, virtual desktop system, distributed computer system, cloud-based system, clustered database, data center, storage area network (SAN), or in any other suitable system.

The storage areas and memory, e.g., memories 162, may be implemented by any quantity of any type of conventional or other memory or storage device, and may be volatile (e.g., RAM, cache, flash, etc.), or non-volatile (e.g., ROM, hard-disk, optical storage, etc.), and include any suitable storage capacity.

Processors 165 are, for example, one or more data processing devices such as microprocessors, microcontrollers, systems on a chip (SOCs), or other fixed or programmable logic, that executes instructions for process logic stored the memory. The processors may themselves be multi-processors, and have multiple CPUs, multiple cores, multiple dies comprising multiple processors, etc.

Servers, e.g., merchant device 120, server device 130, exchange device 140 and banking device 150 may be any server suitable for providing processing services to other applications, computers, clients, etc. A server engine may be a conventional or other server engine that provides the core services for storing, processing and securing data in system 10 in memories 162.

Client devices, e.g., customer device 110, may be any conventional or other computer system or device, such as a thin client, computer terminal or workstation, personal desktop computer, laptop or netbook, tablet, cellular phone, networked television, or other device capable of acting as a client.

The processing nodes are communicatively connected to each other, for example, via communication circuits 168 and network 170, which represent any hardware and/or software configured to communicate information via any suitable communications media (e.g., WAN, LAN, Internet, Intranet, wired, wireless, etc.), and may include routers, hubs, switches, gateways, or any other suitable components in any suitable form or arrangement. The various components of system 10 may include any conventional or other communications devices to communicate over the networks via any conventional or other protocols, and may utilize any type of connection (e.g., wired, wireless, etc.) for access to network 170.

System 10 may include additional servers, clients, and other devices not shown, and individual components of the system may occur either singly or in multiples, or for example, the functionality of various components may be combined into a single device or split among multiple devices. It is understood that any of the various components of the system may be local to one another, or may be remote from and in communication with one or more other components via any suitable means, for example a network such as a WAN, a LAN, Internet, Intranet, mobile wireless, etc.

User interface 163 may include a display device, input device(s), and output device(s), and the other components, and may enable communication with these devices in any suitable fashion, e.g., via a wired or wireless connection. The display device may be any suitable display, screen or monitor capable of displaying information to a user, for example the screen of a tablet or the monitor attached to a computer workstation. Input device(s) may include any suitable input device, for example, a keyboard, mouse, trackpad, touch input tablet, touch screen, camera, microphone, remote control, speech synthesizer, or the like. Output device(s) may include any suitable output device, for example, a speaker, headphone, sound output port, or the like. The display device, input device(s) and output device(s) may be separate devices, e.g., a monitor used in conjunction with a microphone and speakers, or may be combined, e.g., a touchscreen that is a display and an input device, or a headset that is both an input (e.g., via the microphone) and output (e.g., via the speakers) device.

Customer device 110, merchant device 120, server device 130, exchange device 140 and banking device 150 may each be implemented in the form of a processing system, or may be in the form of software. They can each be implemented by any quantity of conventional or other computer systems or devices, such as a computing blade or blade server, thin client, computer terminal or workstation, personal computer, cellular phone or personal data assistant (PDA), or any other suitable device. A processing system may include any available operating system and any available software (e.g., browser software, communications software, word processing software, etc.). These systems may include processors, memories, internal or external communications devices (e.g., modem, network card, etc.), displays, and input devices (e.g., physical keyboard, touch screen, mouse, microphone for voice recognition, etc.). If embodied in software (e.g., as a virtual image), they may be available on a recordable medium (e.g., magnetic, optical, floppy, DVD, CD, other non-transitory medium, etc.) or in the form of a carrier wave or signal for downloading from a source via a communication medium (e.g., bulletin board, network, LAN, WAN, Intranet, Internet, mobile wireless, etc.).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “component,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium, may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a solid state disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a phase change memory storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, e.g., Java, Python, Smalltalk. C, C++, C# and other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should also be noted that, in some alternative implementations, the functions noted in a flowchart or functional block may occur out of the order noted in the figures. For example, two blocks shown in succession may, in fact, be executed substantially concurrently, or the blocks may sometime be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In summary, embodiments of the invention include:

A system comprising: a memory to store cryptographic keys with which an amount of cryptocurrency can be transferred to a memory location in a decentralized electronic ledger; another memory to store other cryptographic keys with which an amount of another cryptocurrency can be transferred to a memory location in another decentralized electronic ledger; a user interface comprising a control by which units of the cryptocurrency are selected; a processor configured to: select a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys; determine a temporal window defining a time in which the sequence of exchange operations is to be completed based on an estimated time interval for completion of the entry into the decentralized electronic ledger and an estimated time interval for completion of the other entry into the other decentralized electronic ledger; and execute the sequence of exchange operations in response to initiation thereof through the user interface within the temporal window.

The system above, wherein the processor is configured to: collect characteristics for exchanges at which the cryptocurrency can be exchanged for the other cryptocurrency and at which the other cryptocurrency can be exchanged for the fiat currency; and select the exchanges for the sequence of exchange operations in accordance with selection criteria on the collected characteristics.

The system above, wherein the selection criteria include whether the estimated time intervals are below respective temporal thresholds.

The system above, wherein the collected characteristics include an estimated time interval over which the fiat currency is made available from an exchange at which the other cryptocurrency is exchanged for the fiat currency.

The system above, wherein the selection criteria includes whether the estimated time interval over which the fiat currency is made available is below a temporal threshold.

The system above, wherein the decentralized electronic ledger and the other decentralized electronic ledger use respective blockchains for the respective entries.

The system above, wherein the processor is further configured to: determine a price amount of a deliverable in the selected cryptocurrency; and display the price amount in the selected cryptocurrency on the user interface.

A method comprising: storing in a memory cryptographic keys with which an amount of cryptocurrency can be transferred to a memory location in a decentralized electronic ledger; storing in another memory other cryptographic keys with which an amount of another cryptocurrency can be transferred to a memory location in another decentralized electronic ledger; generating on a display device a user interface comprising a control by which units of the cryptocurrency are selected; selecting a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys; determining a temporal window defining a time in which the sequence of exchange operations is to be completed based on an estimated time interval for completion of the entry into the decentralized electronic ledger and an estimated time interval for completion of the other entry into the other decentralized electronic ledger; and executing the sequence of exchange operations in response to initiation thereof through the user interface within the temporal window.

The method above, further comprising: collecting characteristics for exchanges at which the cryptocurrency can be exchanged for the other cryptocurrency and at which the other cryptocurrency can be exchanged for the fiat currency; and selecting the exchanges for the sequence of exchange operations in accordance with selection criteria on the collected characteristics.

The method above, wherein the selection criteria include whether the estimated time intervals are below respective temporal thresholds.

The method above, wherein the collected characteristics include an estimated time interval over which the fiat currency is made available from an exchange at which the other cryptocurrency is exchanged for the fiat currency.

The method above, wherein the selection criteria includes whether the estimated time interval over which the fiat currency is made available is below a temporal threshold.

The method above, wherein the decentralized electronic ledger and the other decentralized electronic ledger use respective blockchains for the respective entries.

The method above, further comprising: determining a price amount of a deliverable in the selected cryptocurrency; and displaying the price amount in the selected cryptocurrency on the user interface.

A computer-readable medium having encoded thereon processor instructions that, when executed by one or more processors, cause the one or more processors to: store in a memory cryptographic keys with which an amount of cryptocurrency can be transferred to a memory location in a decentralized electronic ledger; store in another memory other cryptographic keys with which an amount of another cryptocurrency can be transferred to a memory location in another decentralized electronic ledger; generate on a display device a user interface comprising a control by which units of the cryptocurrency are selected; select a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys; determine a temporal window defining a time in which the sequence of exchange operations is to be completed based on an estimated time interval for completion of the entry into the decentralized electronic ledger and an estimated time interval for completion of the other entry into the other decentralized electronic ledger; and execute the sequence of exchange operations in response to initiation thereof through the user interface within the temporal window.

The computer-readable medium above having encoded thereon further processor instructions that cause the one or more processors to: collect characteristics for exchanges at which the cryptocurrency can be exchanged for the other cryptocurrency and at which the other cryptocurrency can be exchanged for the fiat currency; and select the exchanges for the sequence of exchange operations in accordance with selection criteria on the collected characteristics.

The computer-readable medium above, wherein the selection criteria include whether the estimated time intervals are below respective temporal thresholds.

The computer-readable medium above, wherein the collected characteristics include an estimated time interval over which the fiat currency is made available from an exchange at which the other cryptocurrency is exchanged for the fiat currency.

The computer-readable medium above, wherein the selection criteria includes whether the estimated time interval over which the fiat currency is made available is below a temporal threshold.

The computer-readable medium above having encoded thereon further processor instructions that cause the one or more processors to: determining a price amount of a deliverable in the selected cryptocurrency; and displaying the price amount in the selected cryptocurrency on the user interface.

1. A system comprising:
a memory to store cryptographic keys with which an amount of cryptocurrency can be transferred to a memory location in a decentralized electronic ledger;
another memory to store other cryptographic keys with which an amount of another cryptocurrency can be transferred to a memory location in another decentralized electronic ledger;
a user interface comprising a control by which units of the cryptocurrency are selected;
a processor configured to:
select a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys;
determine a temporal window defining a time in which the sequence of exchange operations is to be completed based on an estimated time interval for completion of the entry into the decentralized electronic ledger and an estimated time interval for completion of the other entry into the other decentralized electronic ledger; and
execute the sequence of exchange operations in response to initiation thereof through the user interface within the temporal window.

2. The system of claim 1, wherein the processor is configured to:
collect characteristics for exchanges at which the cryptocurrency can be exchanged for the other cryptocurrency and at which the other cryptocurrency can be exchanged for the fiat currency; and
select the exchanges for the sequence of exchange operations in accordance with selection criteria on the collected characteristics.

3. The system of claim 2, wherein the selection criteria include whether the estimated time intervals are below respective temporal thresholds.

4. The system of claim 2, wherein the collected characteristics include an estimated time interval over which the fiat currency is made available from an exchange at which the other cryptocurrency is exchanged for the fiat currency.

5. The system of claim 4, wherein the selection criteria includes whether the estimated time interval over which the fiat currency is made available is below a temporal threshold.

6. The system of claim 1, wherein the decentralized electronic ledger and the other decentralized electronic ledger use respective blockchains for the respective entries.

7. The system of claim 1, wherein the processor is further configured to:
determine a price amount of a deliverable in the selected cryptocurrency; and
display the price amount in the selected cryptocurrency on the user interface.

8. A method comprising:
storing in a memory cryptographic keys with which an amount of cryptocurrency can be transferred to a memory location in a decentralized electronic ledger;
storing in another memory other cryptographic keys with which an amount of another cryptocurrency can be transferred to a memory location in another decentralized electronic ledger;
generating on a display device a user interface comprising a control by which units of the cryptocurrency are selected;
selecting a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys;
determining a temporal window defining a time in which the sequence of exchange operations is to be completed based on an estimated time interval for completion of the entry into the decentralized electronic ledger and an estimated time interval for completion of the other entry into the other decentralized electronic ledger; and
executing the sequence of exchange operations in response to initiation thereof through the user interface within the temporal window.

9. The method of claim 8, further comprising:
collecting characteristics for exchanges at which the cryptocurrency can be exchanged for the other cryptocurrency and at which the other cryptocurrency can be exchanged for the fiat currency; and
selecting the exchanges for the sequence of exchange operations in accordance with selection criteria on the collected characteristics.

10. The method of claim 9, wherein the selection criteria include whether the estimated time intervals are below respective temporal thresholds.

11. The method of claim 9, wherein the collected characteristics include an estimated time interval over which the fiat currency is made available from an exchange at which the other cryptocurrency is exchanged for the fiat currency.

12. The method of claim 11, wherein the selection criteria includes whether the estimated time interval over which the fiat currency is made available is below a temporal threshold.

13. The method of claim 8, wherein the decentralized electronic ledger and the other decentralized electronic ledger use respective blockchains for the respective entries.

14. The method of claim 8, further comprising:
determining a price amount of a deliverable in the selected cryptocurrency; and
displaying the price amount in the selected cryptocurrency on the user interface.

15. A computer-readable medium having encoded thereon processor instructions that, when executed by one or more processors, cause the one or more processors to:
store in a memory cryptographic keys with which an amount of cryptocurrency can be transferred to a memory location in a decentralized electronic ledger;
store in another memory other cryptographic keys with which an amount of another cryptocurrency can be transferred to a memory location in another decentralized electronic ledger;
generate on a display device a user interface comprising a control by which units of the cryptocurrency are selected;
select a sequence of exchange operations by which the cryptocurrency is exchanged for fiat currency, the sequence of exchange operations including an entry into the decentralized electronic ledger requiring a cryptographic signature using the cryptographic keys and another entry into the other decentralized electronic ledger requiring another cryptographic signature using the other cryptographic keys;
determine a temporal window defining a time in which the sequence of exchange operations is to be completed based on an estimated time interval for completion of the entry into the decentralized electronic ledger and an estimated time interval for completion of the other entry into the other decentralized electronic ledger; and
execute the sequence of exchange operations in response to initiation thereof through the user interface within the temporal window.

16. The computer-readable medium of claim 15 having encoded thereon further processor instructions that cause the one or more processors to:
collect characteristics for exchanges at which the cryptocurrency can be exchanged for the other cryptocurrency and at which the other cryptocurrency can be exchanged for the fiat currency; and
select the exchanges for the sequence of exchange operations in accordance with selection criteria on the collected characteristics.

17. The computer-readable medium of claim 16, wherein the selection criteria include whether the estimated time intervals are below respective temporal thresholds.

18. The computer-readable medium of claim 16, wherein the collected characteristics include an estimated time interval over which the fiat currency is made available from an exchange at which the other cryptocurrency is exchanged for the fiat currency.

19. The computer-readable medium of claim 18, wherein the selection criteria includes whether the estimated time interval over which the fiat currency is made available is below a temporal threshold.

20. The computer-readable medium of claim 15 having encoded thereon further processor instructions that cause the one or more processors to:
determining a price amount of a deliverable in the selected cryptocurrency; and
displaying the price amount in the selected cryptocurrency on the user interface.
